(19) United States
(12) Patent Application Publication
(10) Pub. No.: US 2007/0054690 A1
(43) Pub. Date: Mar. 8, 2007

(54) Adaptive power control mechanism in wlan

(75) Inventors: Keyi Wu, Shanghai (CN); Haoguang Guo, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/569,679

(22) PCT Filed: Aug. 24, 2004
(86) PCT No.: PCT/IB04/51539

§ 371 Date: Feb. 27, 2006

(30) Foreign Application Priority Data
Sep. 2, 2003 (CN) 03155674.4

(51) Int. Cl. H04B 7/00; H04B 1/00

(52) U.S. Cl. 455/522; 455/69

(57) ABSTRACT

A method for power control in WLAN, performed by a wireless equipment, comprises steps of: receiving signals from another wireless equipment in the WLAN; detecting the strength of the received signals; inserting the detecting result of the signal strength as the power control information into the signals to be transmitted to said another wireless equipment. With this power control method, a wireless equipment can automatically calculates and adjusts its transmit power according to the RSSI (received signal strength indication) inserted in the signals.

### FIELD OF THE INVENTION

The present invention relates generally to a method and apparatus for power control in WLAN, and more particularly, to a method and apparatus for power control in WLAN based on IEEE 802.11a/b protocols.

### BACKGROUND OF THE INVENTION

WLAN is a flexible data communication system, by using radio waves to transmit and receive data. Thus it minimizes the requirement for wired connection and combines data connectivity with user mobility. Furthermore WLAN is easy to be deployed, so it is widely used in buildings and on campus as an expansion to, or as an alternative for wired LAN.

Currently, the WLAN based on IEEE 802.11a/b protocols is the most widely applied WLAN. This kind of WLAN adopts unit structure and divides the whole system into several units, each of which is called a BSS (Basic Service Set) and composed of a group of wireless equipments executing the same MAC protocol and sharing the same wireless transmission medium in a contentious way. Each group of wireless equipments consists of a wireless AP and several wireless terminals, and this is the infrastructure—based mode. The several wireless terminals may also communicate with each other directly, without through the wireless AP, and this is called P2P (peer-to-peer) mode.

To avoid the collision caused by several wireless equipments to transmit data by using the same transmission medium simultaneously, IEEE 802.11a/b protocols provide CSMA/CA (Carrier Sense Multiple Access/Collision Detection) technology. With CSMA/CA, wireless equipments use the transmission medium to transmit data only when detecting the transmission medium is free, which greatly reduces the collision caused by several wireless equipments to contend for the transmission medium.

But in some cases, for instance, wireless equipment A transmits data to wireless equipment B, when wireless equipment C can't receive signals from A due to a too long distance, wireless equipment C reckons that the transmission medium is free. And if wireless equipment C also transmits data to wireless equipment B, wireless equipment B can't receive data from the two wireless equipments successfully, which is the so-called “hidden node” problem.

To solve the “hidden node” problem, IEEE 802.11a/b protocols employ RTS/CTS mechanism. Still exemplifying the above wireless equipments A, B and C, after obtaining the right to use the transmission medium through contention, wireless equipment A sends an RTS frame to wireless equipment B for reserving the transmission medium to transmit data with predefined length (usually with the same length as a data fragment in MSDU) before transmitting data to wireless equipment B. After receiving the RTS frame, wireless equipment B returns a CTS frame to wireless equipment A, to notify it to begin transmitting data with predefined length. After receiving the CTS frame, wireless equipment A begins to transmit data with predefined length to wireless equipment B. Wireless equipment C can't receive the RTS frame from wireless equipment A due to a too long distance, but it can receive the CTS frame from wireless equipment B. Accordingly, when wireless equipment A transmits data to wireless equipment B, although wireless equipment C can detect that the transmission medium is free, it knows that wireless equipment A is transmitting data to wireless equipment B at this time, therefore it won't transmit data to wireless equipment B.

To apply RTS and CTS mechanism, each wireless equipment has a NVA timer. After receiving RTS or CTS frame sent from other wireless equipments, the wireless equipment sets its NVA timer as the duration needed for transmitting data with predefined length by said other wireless equipments over the transmission medium. Before the NVA timer expires, the wireless equipment wont' use the transmission medium to transmit data.

Because of using the RTS/CTS mechanism, the wireless AP and wireless terminals who are using the same transmission medium to transmit data can obtain the channel for transmitting data through fa ir contention, as well as avoid the collision caused by using the channel to transmit data.

In a WLAN composed of wireless AP and wireless terminals, the wireless AP is just like a wireless base station in wireless communication, in charge of converging several wireless terminals to a wired network. Wireless terminals are usually portable devices such as notebook computers or PDAs who are generally battery powered.

But the battery of a wireless terminal has limited energy. To efficiently utilize the limited energy, wireless terminals are required to transmit signals at the most suitable power in different situations to save energy. Moreover, with the requirement for mobile office increasing, WLAN will be more and more dense and in such a case the questions of RF interference between different WLANs and frequency reuse will receive more attention.

To solve the above two problems, power control is necessary so that a wireless terminal can automatically adjusts its transmission power according to different dista nce. Transmitting signals at the suitable power not only saves energy but also reduces RF interference between different WLANs and enhances frequency reuse rate. But there's no power control mechanism defined in current WLAN based on IEEE 802.11a/b protocols (some wireless terminals provide several power levels for users to choose, but this has to be done manually and transmission power can't be adjusted automatically and in real time) and communicating wireless equipments transmit signals at nominal power, regardless of the distance.

Therefore, it is of great necessity to add an adaptive power control scheme for wireless equipments in WLAN based on IEEE 802.11a/b protocols.

### SUMMARY OF THE INVENTION

An object of the present invention is to provide a power control method and apparatus for wireless equipments in WLAN, wherein a wireless terminal can estimate its transmission power according to signals transmitted by the wireless AP so that the wireless terminal can automatically choose the suitable power to transmit signals according to its distance with the wireless AP.

Another object of the present invention is to provide a power control method and apparatus for wireless equipments in WLAN, wherein power control message is inserted into signals transmitted by a wireless equipment and another wireless equipment receiving these signals can control power according to the inserted power control message.

Another object of the present invention is to provide a power control method and apparatus for wireless equipments in WLAN, wherein the WLAN “hidden node” problem deteriorated by adopting the power control method in the present invention can be avoided through using RTS and CTS frames.

A power control method is provided to be executed by a wireless equipment in WLAN in accordance with the present invention, comprising: receiving signals from another wireless equipment in the WLAN; detecting the strength of the received signal; and inserting the detection result of the signal strength as the power control message into the signals to be transmitted to said another wireless equipment.

A power control method is provided to be executed by a wireless terminal in WLAN in accordance with the present invention, comprising: receiving signals from the wireless AP in WLAN; detecting the strength of the power testing signal in the received signals; and estimating the transmission power at which the wireless terminal transmits signals to the wireless AP, according to the detection result of the strength of the power testing signal.

### BRIEF DESCRIPTION OF THE DRAWINGS

FIG. 1 is a schematic diagram illustrating the relationship between beacon signals and power adjust points in accordance with the present invention;

FIG. 2 is a block diagram illustrating the RF section of the wireless terminal when implementing the open-loop power control method in accordance with the present invention;

FIG. 3 illustrates transmission of a multiple-data-fragment MSDU in the closed-loop power control method in accordance with the present invention (up and down arrows show the exchange of power control messages);

FIG. 4 shows the proposed PLCP header format with power control field in accordance with the present invention;

FIG. 5 is a schematic diagram illustrating how to avoid the “hidden node” problem by using RTS and CTS frame in accordance with the present invention;

FIG. 6 is a schematic diagram illustrating a notification method of the source wireless equipment after data transmission fails in accordance with the present invention.

### DETAILED DESCRIPTION OF THE INVENTION

Before describing the power control method in the present invention in detail, it should first be clarified that wireless equipments (wireless AP or wireless terminal) using the power control method in the present invention should be compatible with the existing wireless equipments based on IEEE 802.11 protocols.

The power control method in the present invention can be classified into open-loop power control method and closed-loop power control method according to different work principle. Detailed descriptions will be given below to the two power control methods, in conjunction with accompanying drawings.

1 Open-Loop Power Control Method

The open-loop power control method in the present invention adjusts power based on signals transmitted by the wireless AP. Its working principle is as follows:

In a BSS, the wireless AP periodically sends beacon signals to wireless terminals. A wireless terminal in this BSS receives the beacon signals and calculates its RSSI (Receive Signal Strength Indication) according to the received beacon signals. Then the wireless terminal estimates the suitable transmission power according to the calculated RSSI and predefined transmission power estimation criteria. And the wireless terminal transmits signals to the wireless AP with the calculated suitable power.

Wherein the predefined transmission power estimation criteria is to make the power to be the smallest power with which the required data rate can be ensured. As to the predefined transmission power estimation criteria, estimation of the transmission power should have a comprehensive consideration of factors such as receive signal strength, receiver sensitivity, and the adopted transmission model and etc, and in practical applications, the deployment and design of the whole network and the specific propagation environment should also be taken into consideration, which is similar to the method adopted in power control in cellular mobile communication.

The wireless terminal can also estimate its transmission power according to other signals, in addition to beacon signals. But it's the most reliable way to use beacon signals, because they are transmitted periodically.

Since TDD mode is used in WLAN, the uplink and downlink channels can be considered as symmetric. So the measurement result of downlink channel can also be used for uplink channel.

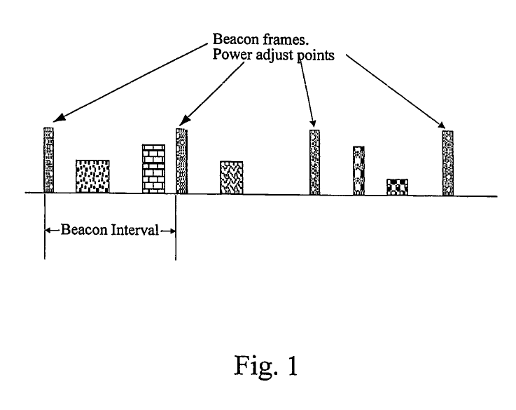

Transmission interval of beacon signals should be selected carefully so that the above open-loop power control method can catch up with the channel change of the WLAN. FIG. 1 is a schematic diagram illustrating the relationship between beacon signals and power adjust points.

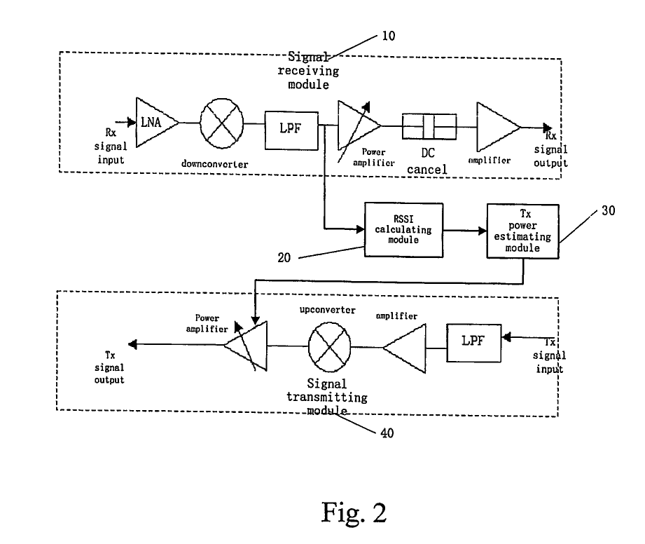

The radio architecture of the RF section of existing wireless terminals is required to be modified to implement the open-loop power control method in the present invention. FIG. 2 is a block diagram illustrating the modified RF section of the wireless terminal. As shown in the figure, the modified RF section of the wireless terminal includes: signal receiving module 10, for receiving signals from the wireless AP; RSSI computing module 20, for detecting the signals received by the receiver module from the wireless AP, and computing the RSSI; transmission power estimating module 30, for estimating the suitable transmission power according to the RSSI computed by the RSSI computing module 20 and the predefined transmission power estimation criterion; signal transmitting module 40, for transmitting signals to said wireless AP at the transmission power estimated by transmission power estimating module 30.

2 Closed-Loop Power Control Method

The closed-loop power control method in the present invention is based on IEEE 802.11a/b MAC protocol. It can perform power control to uplink and downlink channels at the same time.

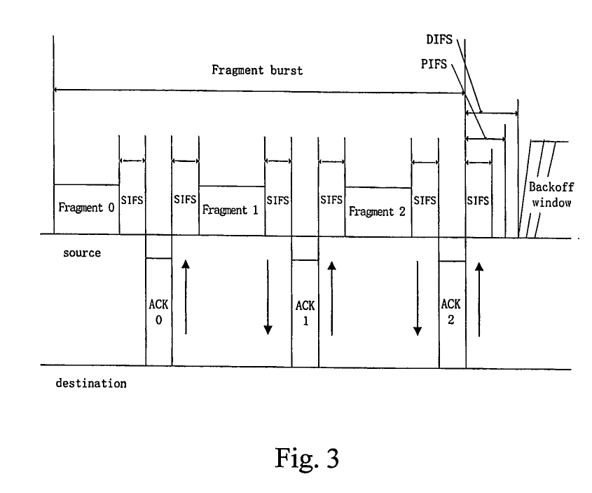

A detailed description will be given below to the closed-loop power control method in the present invention in conjunction with FIG. 3, exemplifying the transmission of a multiple-data-fragment MSDU (up and down arrows show the exchange of power control messages). For simplicity, we call the wireless equipment (wire less terminal or AP) that transmits data as source wireless equipment, and the wireless equipment (wireless terminal or AP) that receives data as destination wireless equipment.

As FIG. 3 shows, the closed-loop power control method in the present invention includes:

The source wireless equipment sends the first fragment Fragment 0 of MSDU to the destination wireless equipment. After receiving Fragment 0 from the source wireless equipment, the destination wireless equipment computes the RSSI according to Fragment 0, and adds the computed RSSI into the ACK message ACK0 of the Fragment 0 to be transmitted to the source wireless equipment, and then sends ACK0 to the source wireless equipment. After receiving ACK0 from the destination wireless equipment, the source wireless equipment adjusts its transmission power for transmitting Fragment 1 to the destination wireless equipment according to the RSSI in ACK0, then computes its RSSI according to ACK0, inserts it into Fragment 1, and in the last transmits Fragment 1 that contains its RSSI to the destination wireless equipment at the adjusted transmission power. After receiving Fragment 1 from the source wireless equipment, the destination wireless equipment adjusts its transmission power to transmit ACK1 to the source wireless equipment according to the RSSI in Fragment 1, then computes its RSSI according to Fragment 1 and inserts the computed RSSI into ACK1, and in the last sends ACK1 that contains RSSI to the source wireless equipment with the adjusted transmission power. And so on, the destination wireless equipment processes the subsequently received fragments from the source wireless equipment in the same way as to Fragment 1, while the source wireless equipment processes the subsequently received ACK messages from the destination wireless equipment in the same way as to ACK0, till the communication ends.

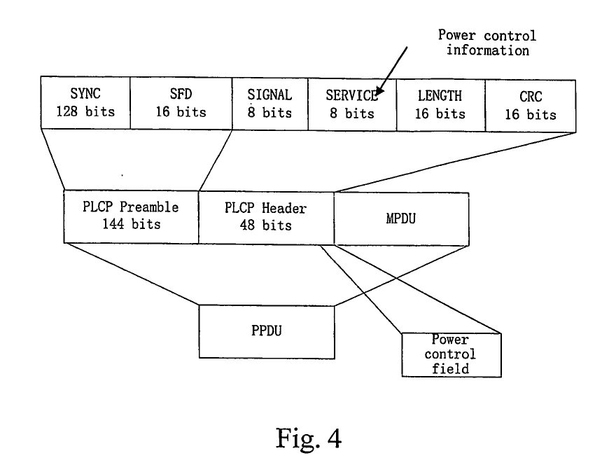

FIG. 4 shows the location of the RSSI in the frame in accordance with the above method. The RSSI can be inserted in the SERVICE field, which is not used at present, within the PLCP header of PPDU. Or an power control field (as FIG. 4 displays, the double lead line means a power control field is added at the back of the PLCP Header, rather than taking the whole PLCP Header as the power control field) can be added in PLCP header and then the RSSI can be inserted herein.

The closed-loop power control method in the present invention is described as above. With this method, wireless equipments (wireless terminal or AP) can adjust transmission power and transmit signals at the smallest power, thus achieve the object of the present invention.

But when data are transmitted with the power control method in the present invention, the innate “hidden node” problem in WLAN will deteriorate if no necessary measures are taken. Because when a wireless equipment is transmitting data using the transmission medium with the power control method in the present invention, its transmission power is generally smaller than that without the power control method, thus more other wireless equipments can't detect that the transmission medium is being used, accordingly collision of contending the transmission medium will happen more easily.

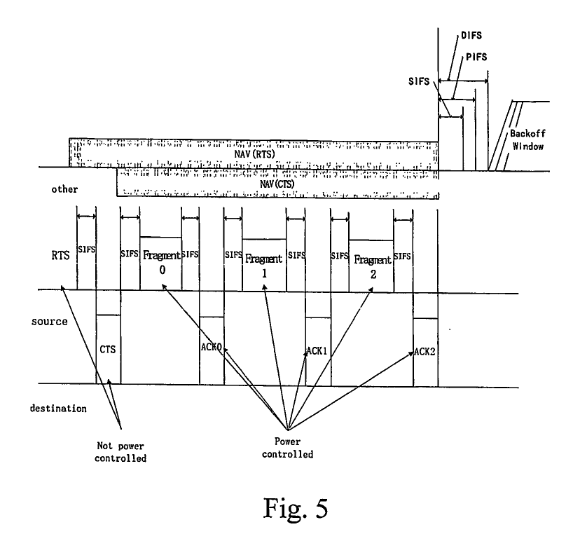

FIG. 5 illustrates a method for using RTS and CTS frames to avoid the WLAN “hidden node” problem deteriorated by adopting the closed-loop power control method to transmit data.

As FIG. 5 illustrates, after obtaining the right to use the transmission medium through contention, the source wireless equipment sends an RTS frame to the destination wireless equipment at the nominal transmission power, to reserve the transmission medium for transmitting data with the same length as MSDU (rather than a fragment in MSDU) before transmitting data to the destination wireless equipment using the transmission medium. After receiving the RTS frame, the destination wireless equipment returns a CTS frame to the source wireless equipment at the nominal transmission power, to notify it to transmit said data with the same length as MSDU. After receiving the CTS frame, the source wireless equipment transmits said data with the same length as MSDU to the destination wireless equipment with the closed-loop power control method as described in FIG. 3. After receiving the RTS frame from the source wireless equipment or the CTS frame from the destination wireless equipment, other wireless equipments in the same BSS set their NAV timers as the duration in which the source wireless equipment transmits said data with the same length as MSDU. Thus, before the NAV timer expires, i.e. during the time the source wireless equipment transmits said data with the same length as MSDU, other wireless equipments in the same BSS won't use the transmission medium to transmit data.

From the above description it can be seen, the method in FIG. 5 can ensure that only the source and destination wireless equipments use the transmission medium to communicate while other wireless equipments in the same BSS won't use the transmission medium during the time in which the source wireless equipment uses the transmission medium to transmit data with the same length as MSDU. This avoids the “hidden node” problem, and the source and destination wireless equipments can use the closed—loop power control method to save energy and reduce interference to adjacent BSSs during communication process.

During data transmission with the closed-loop power control method in the present invention, to avoid the “hidden node” problem in WLAN by using RTS/CTS frames, a corresponding method is needed for notifying other wireless equipments in the same BSS to re-contend the right to use the transmission medium after the source wireless equipment fails to transmit data.

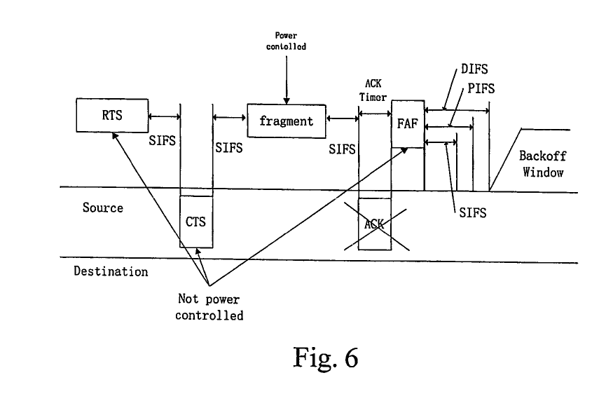

FIG. 6 displays a notification method after the source wireless equipment fails to transmit data. As the figure shows, after data trans mission fails, e.g. the ACK message is not received after the ACK timer expires or data transmission fails due to other reasons, the source wireless equipment sends a FAF (Failure Announcement Frame) frame at the nominal transmission power to other wireless equipments in the same BSS, to notify them that data transmission fails and require them to set their NAV timers to 0. After receiving the FAF frame from the source wireless equipment, other wireless equipments in the same BSS set their NAV timers to 0, and then begin the next round contention for the transmission medium. To re-transmit the data whose transmission fails, the source wireless equipment also joins the contention for the transmission medium.

The closed-loop power control method as disclosed in the present invention, needs support from both hardware and software in wireless equipments.

The power control apparatus for use in a wireless equipment comprises: a receiving means, for receiving signals from another wireless equipment; a detecting means, for detecting the strength of the received signal; an inserting means, for inserting the detection result of the signal strength as the power control information into the signals to be transmitted to said another wireless equipment; an adjusting means, for adjusting the transmission power at which to transmit signals to said another wireless equipment, according to the power control information inserted in said received signal; a transmitting means, for sending an RTS frame to said another wireless equip ment for reserving transmission medium to transmit data with predefined length, and using the reserved transmission medium to transmit data with predefined length to said another wireless equipment after said receiving means receives the CTS frame from said another wireless equipment, furthermore, the transmitting means can send a CTS frame after receiving the RTS frame, and send an FAF frame to other wireless equipments at the nominal power when data transmission fails; and

a contending means, for contending with other wireless equipments for the transmission medium to transmit data.

The open-loop power control method and apparatus and closed-loop power control method and apparatus in the present invention are described above. To attain better result, the above two power control methods and apparatuses can be used jointly.

Moreover, products adopting the power control mechanism in the present invention should be compatible with current 802.11a/b products, so as to communicate with existing products without power control mechanisms. We can easily realize this by adding a mode selecting operation when setting BSS/IBSS or adding a mode bit in the PLCP header, to choose power control mode or not.

Beneficial Results of the Invention

As described above, with regard to the open-loop power control method and apparatus in accordance with the present invention, wireless terminals can automatically adjust their transmission power according to signals transmitted from the wireless AP. As to the closed-loop power control method and apparatus, a wireless equipment can automatically compute and adjust its transmission power according to the RSSI inserted in the signals from another wireless equipment. The “hidden node” problem caused by using the closed-loop power control met hod can also be avoided through utilizing RTS/CTS frame. It is to be understood by those skilled in the art that the power control method and apparatus for use in WLAN as disclosed in this invention can be modified considerably without departing from the spirit and scope of the invention as defined by the appended claims.

1. A method for power control in WLAN, performed by a wireless equipment, comprising steps of:
(a) receiving signals from another wireless equipment in the WLAN;
(b) detecting the strength of the received signals; and
(c) inserting the detecting result of the signal strength as the power control information into the signals to be transmitted to said another wireless equipment.

2. The method according to claim 1, further comprising:
(d) adjusting the transmit power with which to transmit signals to said another wireless equipment according to the power control information inserted in said received signals.

3. The method according to claim 1, wherein said power control information is inserted into the SERVICE field in the PLCP Header in the physical layer PDU (Protocol Data Unit) of the signals to be transmitted.

4. The method according to claim 1, wherein said power control information is inserted into a newly added power control field in the PLCP Header in the physical layer PDU (Protocol Data Unit) of the signals to be transmitted.

5. The method according to claim 1, wherein steps to be taken before executing step (a) further include:
sending an RTS frame to said another wireless equipment to reserve transmission medium for transmitting data with transmit power no less than the nominal value; and
transmitting data to said another wireless equipment by using the reserved transmission medium after receiving the CTS frame from said another wireless equipment.

6. The method according to claim 1, wherein a step to be taken before executing step (a) further includes:
sending a CTS frame to said another wireless equipment with transmit power no less than the nominal value so as to notify said another wireless equipment to start transmitting data through said reserved transmission medium after receiving an RTS frame from said another wireless equipment.

7. The method according to claim 5, wherein said data to be transmitted through said reserved transmission medium is the data with the same length with the MSDU (MAC Service Data Unit).

8. The method according to claim 6, wherein said data to be transmitted through said reserved transmission medium is the data with the same length with the MSDU (MAC Service Data Unit).

9. The method according to claim 1, further comprising steps of:
(e) sending FAF frames to other wireless equipments with transmission power no less than the nominal value if the data transmission fails;
(f) contending with said other wireless equipments for transmission medium to transmit data.

10. The method according to claim 1 can be applied in any one of wireless terminal and wireless access point.

11. A method for power control in WLAN, performed by a wireless terminal, comprising steps of:
receiving signals from the wireless access point in WLAN;
detecting the strength of the signals for power testing in the received signals; and
estimating the transmit power with which the wireless terminal transmits signals to the wireless access point, according to the detecting result of the strength of the power testing signals.

12. The method according to claim 11, wherein said power testing signals are beacon signals transmitted periodically by the wireless access point.

13. A wireless equipment used in WLAN, comprising:
a receiving means, for receiving signals from another wireless equipment in WLAN;
a detecting means, for detecting the strength of the received signals; and
an inserting means, for inserting the detecting result of the signal strength as the power control information into the signals to be transmitted to said another wireless equipment.

14. The wireless equipment according to claim 13, further comprising:
an adjusting means, for adjusting the transmit power with which to transmit signals to said another wireless equipment, according to the power control information inserted in said received signals.

15. The wireless equipment according to claim 13, further comprising:
a transmitting means, for sending an RTS frame to said another wireless equipment with transmission power no less than the nominal value, so as to reserve transmission medium for transmitting data; and using the reserved transmission medium to transmit data to said another wireless equipment after said receiving means receives the CTS frame from said another wireless equipment.

16. The wireless equipment according to claim 13, further comprising:
a transmitting means, for sending a CTS frame to said another wireless equipment with transmission power no less than the nominal value so as to notify said another wireless equipment to start transmitting data through said reserved transmission medium, after receiving an RTS frame from said another wireless equipment.

17. The wireless equipment according to claim 13, further comprising:
a transmitting means, for sending FAF frames to other wireless equipments with transmission power no less than the nominal value when data transmission fails;
a contending means, for contending with said other wireless equipments for transmission medium to transmit data.

18. A wireless terminal used in WLAN, comprising:
a receiving means, for receiving signals from the wireless access point in WLAN;
a detecting means, for detecting the strength of the signals for power testing in the received signals;
an estimating means, for adjusting the transmit power with which the wireless terminal transmits signals to said wireless access point, according to the detecting result of the strength of the power testing signals.

19. The wireless terminal according to claim 18, wherein said power testing signals are beacon signals transmitted periodically by the wireless access point.
